(19) United States
(12) Patent Application Publication
(10) Pub. No.: US 2003/0031091 A1
(43) Pub. Date: Feb. 13, 2003

(54) Method, system, and apparatus for processing seismic data by means of the time-varying optimum offset concept

(76) Inventor: Ki-Young Kim, Chunchon-si (KR)

Correspondence Address: REED & ASSOCIATES, 800 MENLO AVENUE, SUITE 210, MENLO PARK, CA, 94025, US

(21) Appl. No.: 10/187,322

(22) Filed: Jun. 28, 2002

(30) Foreign Application Priority Data
Jul. 26, 2001 (KR) KR10-2001-0045228

(51) Int. Cl. G01V 1/00

(52) U.S. Cl. 367/37

(57) ABSTRACT

Method, system, and apparatus for processing seismic data by means of a time-varying optimum offset concept capable of minimizing both complexity of a common midpoint stacking method and a depth distortion of a optimum offset method. Basic information regarding the seismic data acquired by a data acquisition device is received. The position of a trace window is determined according to a time or an offset of a seismic trace. Only the data included in the trace windows of the seismic traces are horizontally stacked. Since the time-varying optimum offset method, system, and apparatus for seismic reflection data do not need a process of more than ten steps or tests to determine optimum parameters at each step, which are required by the conventional common midpoint stacking method, the processing time and cost are greatly reduced.

### BACKGROUND OF THE INVENTION

1. Field of the Invention

The present invention relates to a method, a system, and an apparatus for processing seismic data by means of the time-varying optimum offset concept, and more particularly to a method of processing seismic reflection data by means of the time-varying optimum offset concept to image subsurface geological structures. Processing seismic data comprising a plurality of complicated and professional steps is greatly simplified, so that subsurface images can be obtained with little professional knowledge, and especially, resulting images depicting real subsurface geological structures can be obtained with or even without velocity information.

2. Description of the Prior Art

As generally known in the seismic exploration, in order to image subsurface geological structures, seismic waves are transmitted into the subsurface of a corresponding area, and seismic information on the subsurface is obtained from reflected seismic waves. The reflected waves are processed to delineate subsurface geological structures. For adequate processing seismic data, basic information on field geometry is needed such a vertical and horizontal positions of shots and receivers, shot intervals, geophone spacings, record length sample rates, and velocities of air and Rayleigh waves.

FIG. 1 is a schematic block diagram of an apparatus for imaging geological structures.

As shown in FIG. 1, the apparatus for imaging geological structures comprises a data acquisition device 100 and a data processing device 150. The data acquisition device 100 acquires basic information in order to image subsurface geological structures properly. The data processing device 150 analyzes, deciphers, and images geological structures according to the basic information from the data acquisition device 100.

FIG. 2 shows an embodiment of acquiring data by the data acquisition device 100. The data acquisition device 100 includes a generator 110, a receiving section 120, and a recording section 130. The generator 110 generates seismic waves. The generator 110 employs seismic explosives or vibrators to send seismic signals to deep reflectors. The generator 110 may employ a hammer, a weight drop, small charges of seismic explosives, or a small vibrator for shallow targets.

The receiving section 120 receives seismic waves generated by the generator 110. The receiving section 120 includes a plurality of receivers 120a, 120b, 120c, and 120d. In this case, a geophone composed of a magnet and a coil or geophone groups are employed as the receiver on land, while a hydrophone having piezoelectric material inside or more generally a streamer cable composed of many hydrophone groups are employed as the receiver at sea. As an example of the receivers, the geophone will be described below.

The recording section 130 records the seismic data received by the receiving section 120, and transmits them to a processor 160 of the data processing device 150. In transmitting the data, the recording section 130 either directly transmits the obtained data through a cable, or stores the data in a storage device first and then transmits them to the data processing device 150. In the latter case, the storage device may be a diskette, a compact disc (CD), or a magnet tape. The processor 160 of the data processing device 150 processes the data acquired by the data acquisition device 100 so as to obtain subsurface images. A display section 170 of the data processing device 150 displays the result processed by the processor 160.

In this case, the processing method adopted by the processor 160 is an issue.

When the processor 160 processes raw seismic data, a common midpoint (CMP) stacking method, which is widely employed in the field of exploration for petroleum, has been mainly used as a method for processing to enhance signal-to-noise ratio of seismic reflection data. In the CMP stacking method, a dedicated computer system of at least a workstation class should have been employed as the data processing device 150, and a process comprising more than ten steps should be carried out. CMP gathers consist of data obtained by collecting a plurality of traces reflecting from common reflection points, after sorting various common shot gathered data which are recorded at various shot locations into CMP locations.

In the CMP stacking method, representative processing steps include demultiplexing, format conversion, source/receiver geometry input, true amplitude recovery, elevation correction, trace edit, f-k filtering, muting (inside/outside), deconvolution, wide-band frequency filtering, CMP sort, velocity analysis, normal move-out (NMO) correction, residual static correction, stacking, and migration.

Hereinafter, functions of several main steps among the representative steps will be briefly described.

The format conversion is a step of converting a recording format into an internal format of processing software.

The source/receiver geometry input is a step in which shots and receiver locations corresponding to each shot are inputted into a computer.

The elevation correction is a step in which a time difference due to elevation variation at each shot and receiver points is changed.

The f-k filtering is a step where seismic signals are passed while noise is injected in the f-k (frequency-wavenumber) domain, so as to improve signal-to-noise ratios (S/N).

The trace edit and mute steps are steps in which noise is removed in the t-x (time-offset) domain by records, trace, and receiver locations. In this step, reversed polarities of traces are also corrected.

The CMP sort is a step in which common shot gathered data are classified into common midpoints using geometry information on shot and receiver positions of all traces.

Furthermore, the velocity analysis is a step in which stacking velocities are obtained by analyzing the CMP data. The normal move-out correction (hereinafter, referred to as NMO correction) is a step in which a data point at a travel time t is transferred to a zero offset travel time t₀ by means of a velocity function obtained in the previous velocity analysis step.

The stack is a step in which NMO-corrected CMP traces are superimposed by CMP location and then all stacked traces are integrated into a section.

The migration is a step of transferring reflection events on a stack section to their proper locations.

The CMP stacking method has an advantage in that it gives precise subsurface images. However, each step is performed by a module and attains different results according to process sequence and selected parameters. That is, an analyst should perform a test for determining optimal process parameters for each step. This means that the process involves much time and efforts and also requires the analyst to have professional knowledge. Furthermore, the CMP stack method is problematic in that reflected waves from shallow boundaries are seriously distorted due to stretches, compression, and sample reversion.

In order to solve such problems inherent in the CMP stack method as described above, an optimum offset processing method, which is an alternative to the CMP method, has been used.

In the optimum offset method, a section is made by means of only one trace with an optimum offset selected from each common shot record, so as to overcome the problems inherent with the CMP stack method which requires professional knowledge and much time in processing.

The optimum offset method can simply and quickly attain a resultant section. Also the optimum offset processing method can successfully make a seismic section without any knowledge of the velocity function with respect to depth. However, depths of strata on the optimum offset section appear to be deeper than their actual depths, thereby distorting a total section. This kind of distortion does not generally become an issue with deep seismic data. Instead, low signal-to-noise ratio is often an obstacle in interpreting deep structures. However, such a drawback due to wrong estimation in depth creates serious problem with shallow seismic data.

### SUMMARY OF THE INVENTION

Accordingly, the present invention has been made to overcome the above-mentioned problems occurring in the prior technology. An objective of the present invention is to provide a method, a system, and an apparatus for processing seismic data by means of the time-varying optimum offset concept. With the newly introducing concept, both complexity of the common midpoint stacking method and depth distortion of the optimum offset processing method can be minimized by changing the optimum offset according to reflection time or depth of reflector.

Another objective of the present invention is to provide a method, a system, and an apparatus for processing seismic data by means of the time-varying optimum offset concept, which is capable of horizontally stacking reflection data in a window in the time-distance domain by setting a suitable length of a window between two boundaries. The windows can be set with a suitable length based on the data recorder before air-wave arrivals.

A further objective of the present invention is to provide a method, a system, and an apparatus for processing seismic data by means of the time-varying optimum offset concept, which is capable of making a seismic section more approximate to a real one than an optimum offset method without CMP sorting step and velocity information which are always needed in the conventional CMP stack method.

In the method, the system, and the apparatus for processing seismic data by means of the time-varying optimum offset concept according to the present invention it can be applied better to CMP data when apexes of reflection hyperbolae appear at zero offset. In addition, performing dynamic corrections with velocity information at only one or two locations, the present invention provides better results where reflectors are imaged at places much nearer to their actual depths.

In the present invention, the following sequence is necessary for processing seismic reflection data in order to accomplish the objectives described above. The first step is to input basic information of seismic data recorded through the acquisition system. The next is to determine proper position of a trace window according to time or offset of seismic data. The final step is to horizontally stack seismic data only in the trace window. The present invention also provides a system, apparatus, and recording medium capable of performing the method.

The method, system, and apparatus according to the present invention further include a step of or means for illustrating the data, which have been horizontally stacked, so as to produce subsurface seismic reflection images.

In the method, system, apparatus, and recording medium according to the present invention as described above, it is preferred that the basic information includes vertical and horizontal positions of source and receivers shot interval, receiver interval, record length, sample rate, and velocities of air and Rayleigh waves. An optimum time window is set above the arrival time of the faster waves between the airwave and Rayleigh waves. Further, in the method, system, apparatus and recording medium according to the present invention, it is preferred to use velocity information in the implemented area whenever possible for better delineation of subsurface structures. Preferably, the trace window determines a useful portion of the seismic wave trace, and the length of the trace window is to be varied according to time or offset.

Furthermore, it is preferred that tapers are set at both upper and lower boundaries of the trace window, so as to reduce signal distortions due to a sudden data stoppage of the seismic trace at the edges of the trace window.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing an apparatus for imaging geological structures;

FIG. 2 is a view showing one embodiment which acquires raw seismic data by a data acquisition device;

FIG. 3 is a flow chart illustrating a time-varying optimum offset processing method according to an embodiment of the present invention;

FIG. 4a is a graph illustrating a seismic signal and a trace window whose position is fixed;

FIG. 4b is a graph illustrating a seismic signal and a length-varying trace window whose position is fixed according to time or offset;

FIG. 5 shows graphs illustrating a normal move-out connection;

FIGS. 6a to 6c are views showing an example of FORTRAN code, which can be employed in a method for processing seismic data by means of the time-varying optimum offset concept, according to an embodiment of the present invention;

FIG. 7 is a view illustrating a synthetic seismic section obtained through computer simulations;

FIG. 8a is a sectional view of a synthetic subsurface image obtained through a CMP stack method;

FIG. 8b is a view showing a shot gather at Trace 60 on FlGS. 8c through 8e;

FIG. 8c is a sectional view of a subsurface image which is a result obtained by a conventional optimum offset processing method;

FIG. 8d is a sectional view of a subsurface image indicating a result acquired without using velocity information according to the present invention; and

FIG. 8e is a sectional view of a subsurface image indicating a result obtained using velocity information according to the present invention.

### DETAILED DESCRIPTION OF THE PREFERRED EMBODIMENTS

Hereinafter, a method, a system, and an apparatus for processing seismic data by means of the time-varying optimum offset concept according to preferred embodiments of the present invention will be described in detail with reference to the accompanying drawings.

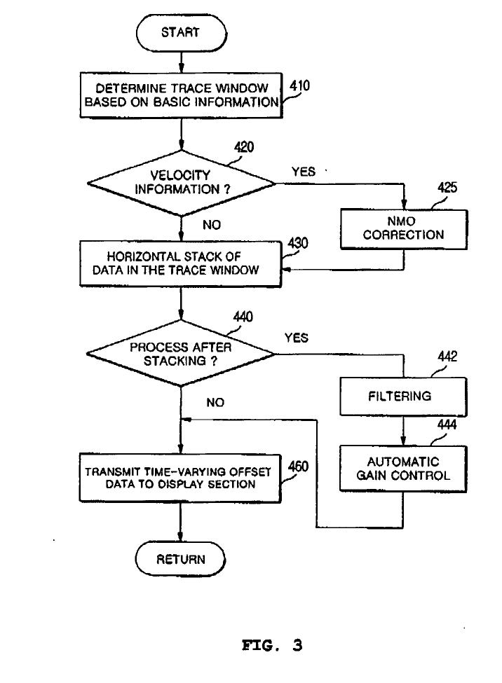

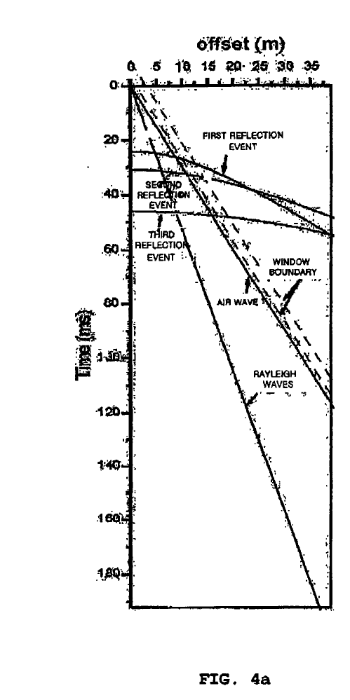

FIG. 3 is a flowchart illustrating a method for processing seismic data by means of the time-varying optimum offset concept according to an embodiment of the present invention.

In the method shown in FIG. 3, a processor of a data processing device firstly determines a trace window based on basic information inputted from a data acquisition device 100 (step 410). A trace is a relative motion record of ground received by one geophone, that is, a receiver. The trace window determines a useful signal portion of the basic information. Based on the velocity of the faster of either the air wave or the Rayleigh wave, a portion of the trace for a predetermined time which is faster than the velocity of the faster wave is selected for the inside of the trace window. Based on the velocity of the faster wave between the air wave and the Rayleigh waves, a portion of the trace is selected for the trace window at a predetermined time which is earlier than the arrival time of the faster wave.

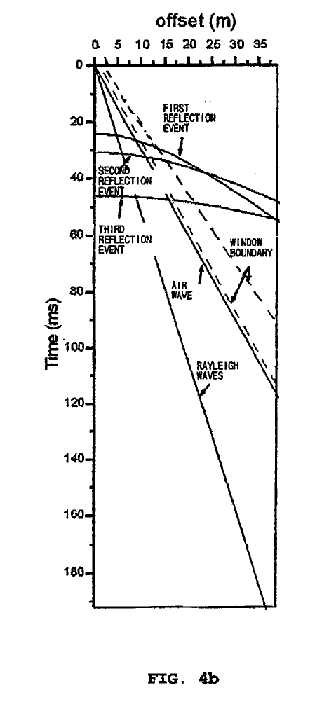

A method for determining the trace will be described with reference to FIGS. 4a and 4b.

FIG. 4a is a graph which illustrates a seismic signal and a trace window whose position is fixed.

Referring to FIG. 4a, since the velocity of the Rayleigh wave is 210 m/s and the velocity of the air wave is 335 m/s, the trace widow is set to have a slope of 335 m/s which is the velocity of the air wave. The trace window starts at a time obtained by subtracting a clearance width of fifteen samples (3 ms) from the arrival time of the air wave. Six milliseconds, which is equal to the dominant period of signal, is selected as the length of the trace window.

FIG. 4b is a graph illustrating a seismic signal and a trace window whose length varies with time or offset. Referring to FIG. 4b, the length of the trace window is determined in such a manner that the trace window should include one wavelength of the signal where the signal-to-noise ratio is high. Therefore, the length the trace window should be shorter with data of high frequency signals data of lower ones. Further, the length of trace window in FIG. 4b can be changed according to time. That is, the length of trace window can be increased proportionally with time. Since signal-to-noise ratio generally decreases as reflection time increases, the stack fold is better to be increased by increasing number of stacking trace. The number of trace can be practically increased by increasing the length of trace window.

In order to reduce signal distortion due to a sudden data stoppage, a taper of fifteen samples (3 ms) is used. The taper of a ramp function is set at an edge of each trace window and weighting factors are varied from zero to one at the upper boundary and from one to zero at the lower boundary of a trace window.

Referring again to FIG. 3, the processor judges whether or not velocity information is contained in the basic information on the seismic data (step 420). As a result of the judgment in step 420, when the velocity information exits in the basic information on the seismic data, the processor 160 performs a normal move-out correction (step 425).

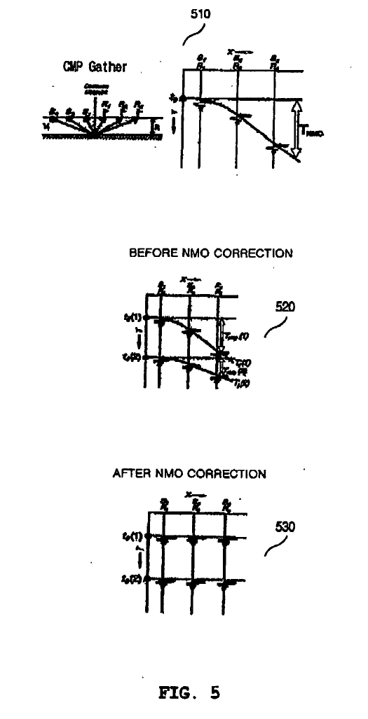

FIG. 5 includes graphs illustrating a process of the normal move-out correction.

Referring to FIG. 5, a reference numeral 510 represents one embodiment of the present invention, in which seismic waves are generated by a wave source S and received by receivers R. A CMP gather is obtained on the basis of common midpoints. T_{NMO} represents a time which is subjected to be normally moved out. A reference numeral 520 indicates a trace before performing the normal moveout (NMO) correction, while a reference numeral 530 indicates a trace after performing the NMO correction. In the NMO correction as described above, data recorded at a travel time t are transferred to a zero offset travel time to using a velocity function. Only when a correct velocity function is available, we can get correct depths of reflectors, as shown in the graph 520. With reference again to FIG. 3, when the velocity information is not included in the basic information on seismic data at a judgment of step 420 or after step 425 is performed, the processor performs horizontal stacks of data in the trace windows of traces in order to obtain time-varying optimum offset stack data showing subsurface images (step 430). The horizontal stacking is a process in which seismic traces of a record are summed together by time.

Before transmitting the obtained time-varying optimum offset data, filtering can be performed to improve a signal-to-noise ratio (step 442) and an automatic gain control operation can be performed to restore a weak signal (step 444). Since it is well known to those process, detailed description of the steps 442 and 444 are omitted.

The processor transmit the obtained time-varying optimum offset data to a display section (step 460). The display section outputs the time-varying optimum offset data using output devices such as a monitor and/or a printer.

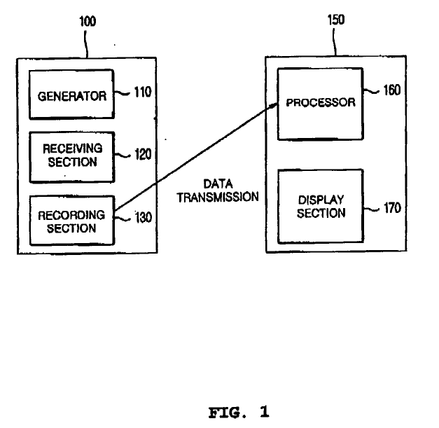

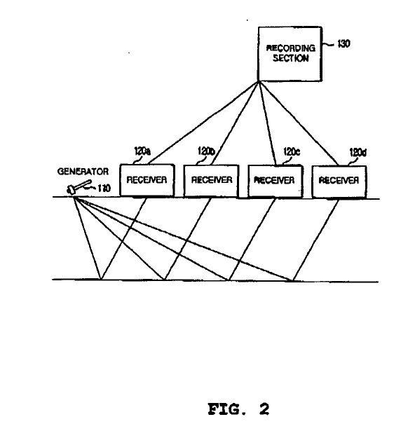

With reference to FIG. 1, a conventional apparatus for obtaining a subsurface image section includes a data acquisition device 100 and a data processing device 150 which are separately formed. When the processor 160 of the data device 15O processes data acquired by the data acquisition device 100 using a CMP stacking method, as mentioned above, a complicated process comprising at least ten steps should be performed and processing time is longer, so that a workstation class computer or a higher level computer should be used. In general, however, it take from several days to several weeks to process a line of reflection data. The present invention integrates and simplifies the overall processing steps into one step. According to the present invention, since a result with respect to a subsurface image section can be obtained in a short time (within several seconds), the data acquisition device and the data processing device can be integrated into one. Accordingly, a user can obtain subsurface images almost on the spot.

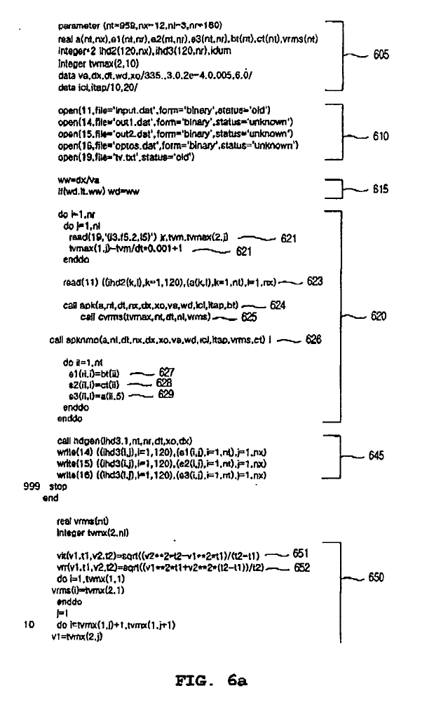

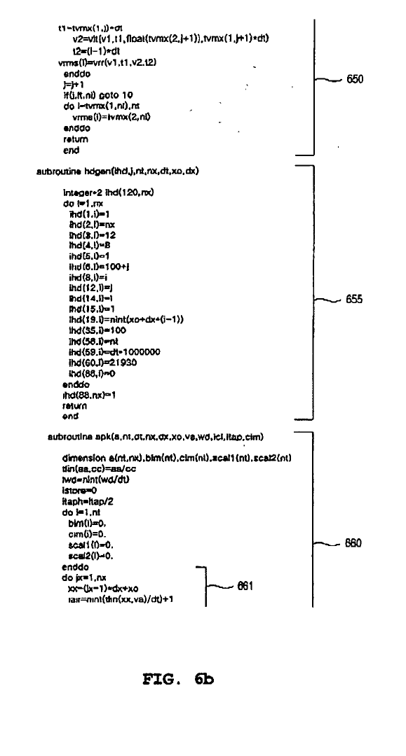

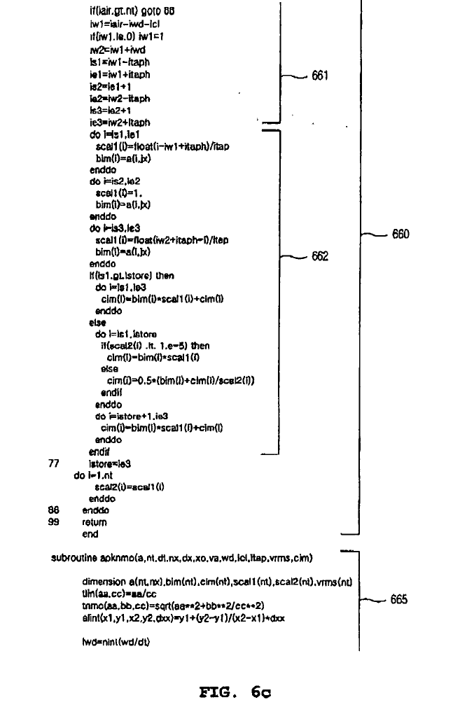

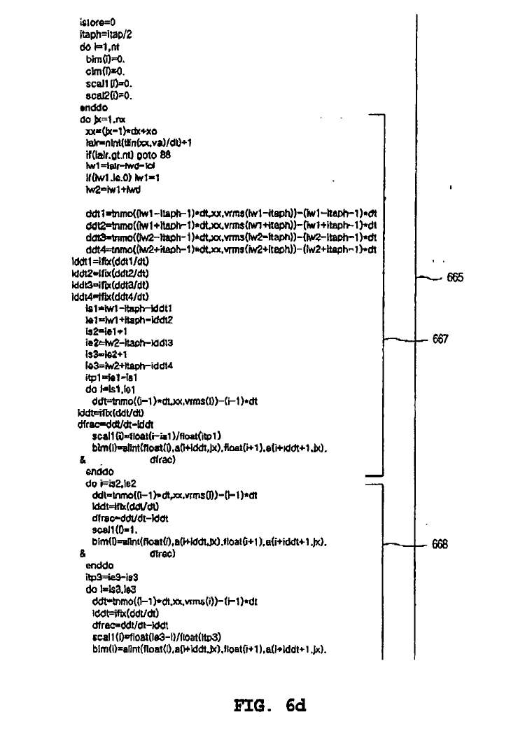

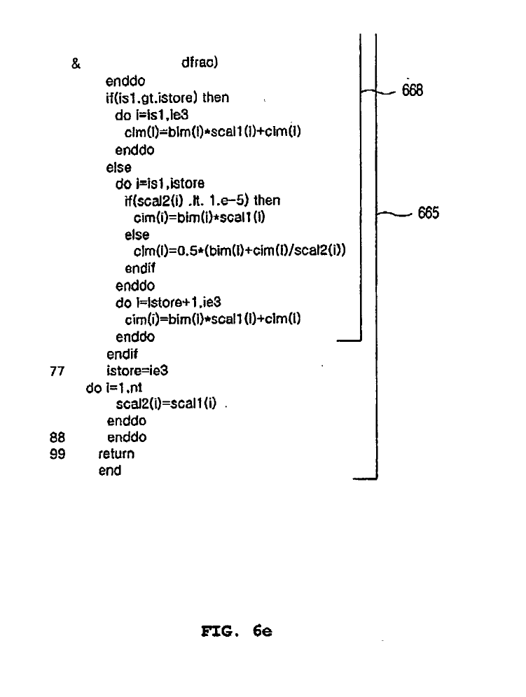

FIGS. 6a to 6e are views showing one example of a FORTRAN code which can be used for a time-varying optimum offset method according to an embodiment of the present invention.

Since it is well known to those skilled in the art, a detailed description on the FORTRAN language is omitted.

Referring to FIGS. 6a to 6c, the FORTRAN code forms software developed for processing seismic reflection data based on the present invention. The computer program reads and processes 180 (nr) data (input.data) recorded with twelve channels (nx) by a sample rate (dt) of 0.2 ms, and writes a stacking result to an output file (out1.dat).

Further, when the velocity information is included in the basic information on seismic data, the processor reads the velocity information from the file ‘tv.dat’ and writes NMO corrected result on the file ‘out2dat’. For the purpose of comparison, a dataset obtained by the conventional optimum offset method is outputted to the file ‘optos.dat’.

Parameters and data with respect to user-defined functions are designated in part 605.

A source and a target are designated in part 610.

The length of trace window id designated in part 615, where a parameter ‘wd’ represents the length of trace window.

Data are inputted and processed in part 620, where the parameter ‘nr’ represents the number (180) of records, and a parameter ‘nl’ represents the number (three) of strata.

Part 620 will now be described in detail. The velocity information is read from part 621. Velocity information according to identification number of reflector is stored at the variable ‘tvmax’ in part 622. Input data are read from part 623. In part 624, an optimum time-varying window is determined and a subprogram and a subprogram is called to perform a horizontal stacking. When the subprogram is called from the part 624, the processor approaches part 660 and determines the optimum time-varying window to perform the horizontal stacking. The result is stored in an eal array ‘e1’ at part 627.

Part 661 in part 660 is a part where the optimum time-varying window is determined. Part 662 in the part 660 is the part which performs the horizontal stacking. Part 620 will now be described in detail. Parameter ‘iwd’ is obtained by changing a window boundary ‘wd’ from a time unit to a sample unit. Parameter ‘itap’ represents a length of taper for removing the edge effect. Parameter ‘nx’ represents the number of channels, that is, twelve in this example code. Parameter ‘xx’ represents the offset to each channel. Parameter ‘iaix’ represents the travel time in number of samples of the airwave. The trace time of air wave is computed by dividing parameter ‘xx’ parameter ‘da’, converting the divided result from a time unit to a sample unit, and adding 1 to the converted number to set the first sample top zero second. Also parameter ‘nt’ represents a total length of a trace. Parameters ‘iw1’ and ‘iw2’ represent starting and ending sample numbers of a time window on a trace, respectively. Similarly, parameters ‘is1’ and ‘ie1’ represent starting and ending sample numbers of a taper on the upper edge of time window based on the parameter ‘iw1’, respectively. Parameters ‘is2’ and ‘ie2’ represent starting and ending sample numbers of a span without a tape, respectively. Parameters ‘is3’ and ‘ie3’ represent starting and ending sample numbers of a taper on the lower edge of time window based on the parameter ‘iw2’, respectively. Part 625 is an essential part when the velocity information is used. The part 625 is a part which calls a subprogram for calculating an root-mean squared (RMS) velocity (vₘₛ) of each sample. When the subprogram is called from the part 625, the processor approaches to part 650 and calculates the RMS velocity of every sample.

Part 651 in the part 650 represents an equation which calculates a Dix interval velocity from RMS velocities. Part 652 in the part 650 calculates RMS velocity at every sample from the Dix interval velocities.

Part 626 is a part for determining an optimum offset time-varying window, performing NMO corrections using RMS velocities obtained from part 652, and calling a subroutine to perform the horizontal stacking. When the subroutine is called from the part 626, the processor approaches part 665, performs the NMO corrections using the RMS velocities calculated in the part 625, and performs the horizontal stacking. The result is stored in an real array ‘e2’ at part 628.

Part 667 in part 665 is a part which determines the optimum time-varying window. Part 668 in the part 665 is a part which performs the horizontal stacking after performing the NMO correction.

Parts in part 665 other than the parts described in the part 660 will now be described. In part 666 of the part 665, ‘ddt1’, ‘ddt2’, ‘ddt3’, and ‘ddt4’ represent normal moveouts at each taper edge.

Referring to FIG. 3 again, the processor judges availability of velocity information at part 621. (step 420). When there is no velocity information available, part 624 calls art 660 of a subprogram to perform the horizontal stack (step 430). If velocity information is available, part 625 calls part 650 of a subprogram to compute RMS velocities, and calls the part 665 of a subprogram to perform both NMO corrections (step 425) and horizontal stacking (step 430). Referring to FIGS. 6a to 6e again, part 629 is a step in which results fom the conventional optimum offset are stored in an real array ‘e3’. The data by the optimum offset processing method is stored and outputted in order to the conventional method with a method according to the present invention. Therefore, this part can be omitted when the program is actually used for routine application.

The part 645 calls the part 655, which is a subprogram thereof, and outputs data, in order to input header information.

The program includes a data input step, an operation step, and an output step. The input step includes an interactive input step and a batch-mode input step. Further, any commonly used scientific computer languages such as BASIC, FORTRAN, and C can be used to embody the present invention. Output products can be obtained by utilizing a conventional software. In an embodiment of the present invention, data is inputted in a batch mode. The FORTRAN language is selected to embody the program. The output sections are expressed using WINSEIS, a third party software.

Hereinafter, in order to promote understanding of the present invention, subsurface image sections which are obtained by a computer simulations as well as a real measurement will be explained in detail.

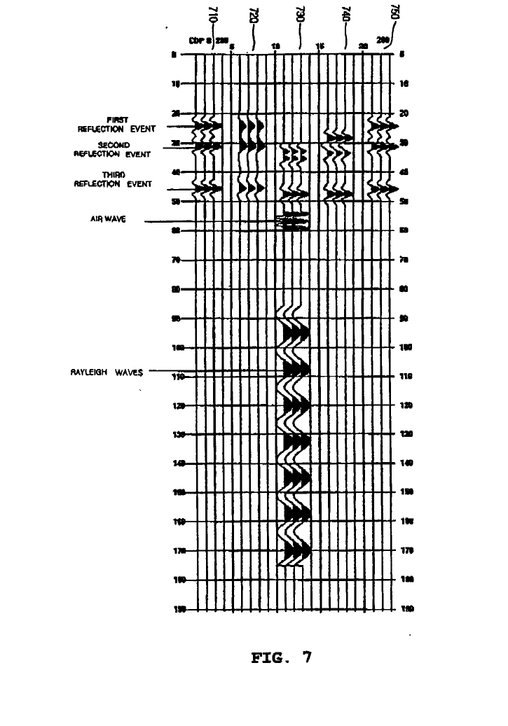

FIG. 7 is a view which illustrates a subsurface image section acquired by a simulation on a computer. With reference to FIG. 7, part 710 indicates an ideal zero-offset section of subsurface images. The cross section of subsurface images in the part 710 is a result obtained by convoluting a zero-phase wavelet with a dominant period of 4.2 ms with reflection coefficient series.

Part 720 is a cross section of subsurface images obtained through conventional CMP stacking method which is the most commonly employed in a seismic reflection data processing. In the stacked section of subsurface images in the part 720, the first and second upper reflection events of shallow depths are shown to be stretched. The vertical resolution of the events is lower than that of the ideal section on the part 710.

Part 730 is a cross section of a subsurface image obtained through another conventional method, the optimum offset processing. In the optimum offset cross section of subsurface images in the part 730, reflection boundaries appear to be delayed in time compared with the ideal section in the part 710. Particularly, such a delay is severe for shallow events. Air wave appears near 54 ms and Rayleigh waves near 85 ms.

Part 740 is a cross section of a subsurface image obtained through the time-varying optimum offset method of the present invention without using velocity information. In the cross section of a subsurface image in the part 740, reflection boundaries are well recognized without undesirable stretches from the CMP stack in the part 720 and pseudo-images from the optimum offset section in the part 730. In comparison with the ideal result in the part 710, however, reflection times are not exact but delayed by 1.7-4.5 ms when the NMO correction is not performed.

Part 750 is a cross section of a subsurface image obtained through a processing method of the present invention using velocity information. In the cross section of a subsurface image in the part 750, reflection surfaces appear at ideal time exactly as a result of NMO correction. It looks that waveforms are quite similar to those of the ideal result of the part 710.

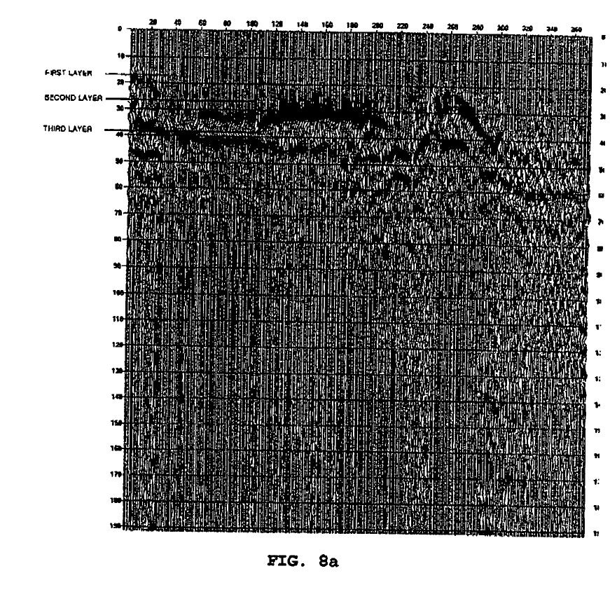

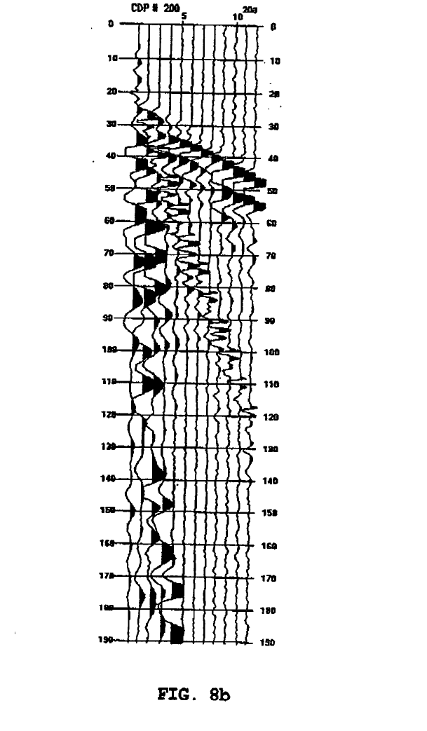

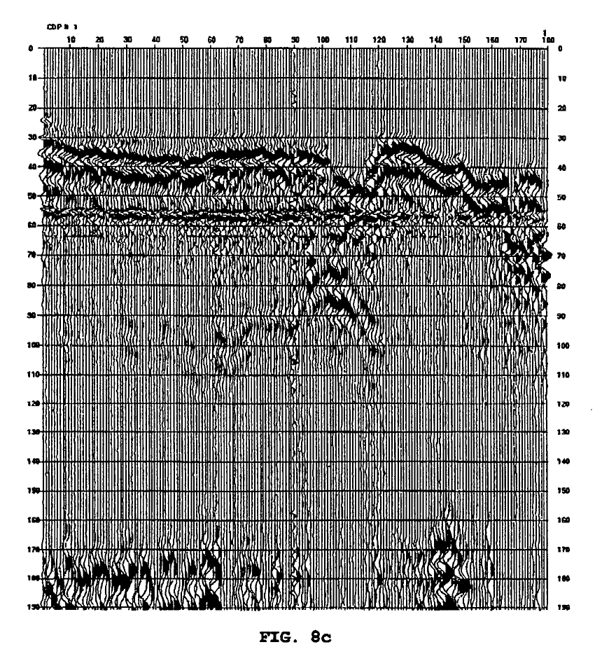

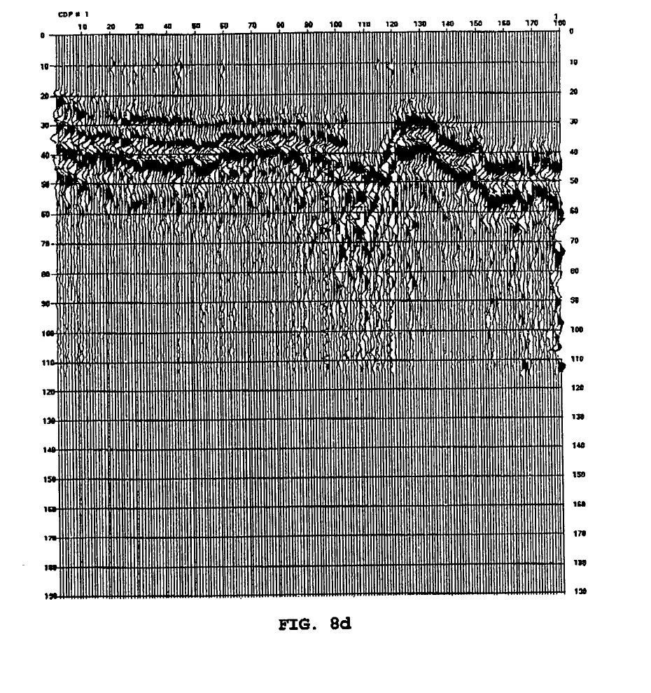

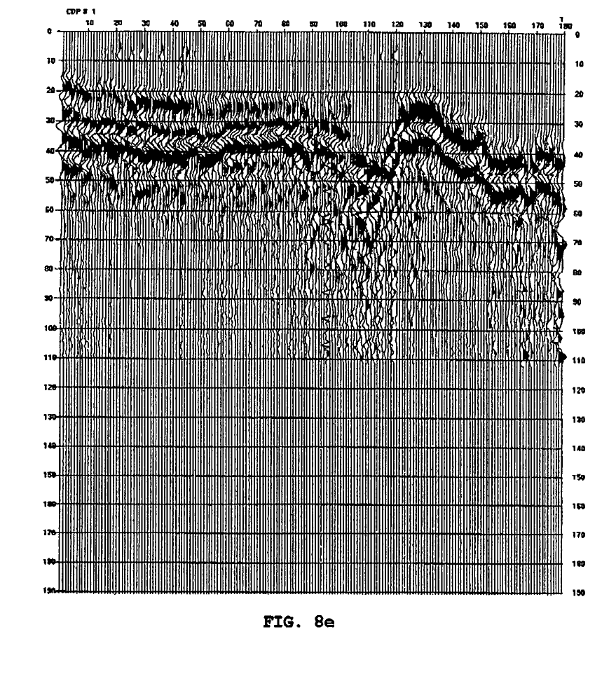

FIGS. 8a through 8e are views which illustrate surface image sections obtained through a real measurement.

The data are acquired at a rice field with little undulation between Gyeong-ju city and Angang town in Gyeongsangbuk-do in the Republic of Korea. A reflection profile of 553 m is set on a farm road perpendicular to the major fault direction. A total of 180 records are acquired with a sample rate of 0.2 ms for a record length of 192 ms. Seismic signals are generated by striking a hammer of 5 kg on an aluminum plate seated on the ground. Twelve high-frequency geophones with a resonance frequency of 100 Hz are used as a receiving section. A GeoPro 8012A twelve-channel digital seismic recorder of Bison Instruments Co., Ltd. in U.S.A. was used as a recording section. An analog high frequency pass filter of 150 Hz was used at field. The recorded data are transmitted to a notebook personal computer through an RS-232C cable having a velocity of 9,600 bps by means of a communication software.

FIG. 8a is a cross section of a subsurface image which is a result obtained by a conventional CMP method.

Referring to FIG. 8a, a total of 180 common shot gathers are sorted into CMP gathers. The number of traces in the subsurface section is 373. The first layer has a thickness from 7.8 m to 12.6 m. The interval velocity of the first layer calculated using Dix's formula (1955) turns out to be between 640 m/s and 1020 m/s. The first layer is interpreted as a dry unconsolidated layer based on the calculated interval velocity. From left to right on the seismic section, the stacking velocity tends to decrease. Most shallower and slow events identified on some noise-analysis data at an 1 m interval do not appeared on the stacked section with a near-offset of 6 m due to large stretches.

The second layer has a thickness from 4.7 m to 12.0 m. The second layer judged based on its interval velocity is a saturated unconsolidated sedimentary layer. The layer is interpreted to be divided into three sections.

The first part of this layer in the CMP range of one to 190 has an average interval velocity of 1638 m/s and an average thickness of 6.9 m. The velocity of this part is higher than those of other parts. Due to the large difference in velocity between the first and the second layers, relatively continuous and strong reflections appear in the first part of the second layer.

The thickness of the unconsolidated sediments is matched well with the average depth of a magnetic basement of 8.5 m computed by KIM Ki-Young and LEE Kwang-Ja through micro-gravity and magnetic studies. Considering the difference in interval velocity, lithology comprising this layer may vary. In the middle part between CMP 190 and 254, the second layer has an average interval velocity of 1347 m/s and an average thickness of 10.3 m. This part is though as a fracture zone based on the observations that the boundary between the uppermost layer and this second layer is not clear and that several faults are found at a lower boundary of this layer even though faults cutting this layer are not well imaged. Therefore, the part seems to be fractured more severely than other parts.

The third part corresponds to the CMP range between 254 to 373. The average interval velocity and thickness of this part are 1170 m/s and 8.7 m, respectively. The velocity is relatively lower than those of other parts. The slope of the reflection boundary between the first and second layers gradually decreases. Faults are recognized based on several identification criteria such as presence of diffraction hyperbola, cutoff or loss of reflectors, and sudden changes of stacking velocity. Sixteen faults are identified along the profile. And six of them are identified in the third part, and three of the six faults found in the fault zone. Based on the above observations, the latest movement of the faults is recent. Since dips of most faults are greater than 70 degrees and also based on other geological information in the region, the fault motions may be the strike-slip type.

In addition, reflection events from the acoustic basements show a strong ringing character indicating large differences in acoustic impedance between the overburden layer and the acoustic basement.

The third layer has a thickness from 11.0 m to 19.1 m. The interval velocity of this layer has a value between 1418 m/s and 2191 m/s. Like the case with the second layer, there is a large difference in interval velocity of this layer between the right and left sides of the fracture zone near CMP 213. The left part of this layer shows higher velocity compared with the right part.

It is believed that the third layer has been formed through weathering of an upper portion of the acoustic basement. This third layer has a wider range of stacking velocity than those of other layers. The reflection event between the acoustic basement and the third layer is observed only left of CMP 200. The reason why the reflection is not imaged beyond CMP 200 may be either lack of reflection boundary or insufficient source energy.

Horizontal axes in FlGS. 8b, 8c, 8d, and 8e indicate either shot locations or receiver locations, not CMP locations as in FIG. 8a. Hereinafter, the shot or geophone locations are referred to as station numbers. Accordingly, a section of 180 stations is shown at a trace interval of 3 m in FlGS. 8c through 8e which will be described. FIG. 8b is a shot gather at station number 60 on stations in FIGS. 8c through 8e. In FIG. 8b, the first reflection event appears near 26 ms on trace number 1 and the second and the third reflections are near 31 ms and 38 ms on trace number 2, respectively.

FIG. 8c is a cross section of subsurface images obtained through the conventional optimum offset processing.

FIG. 8c shows a seismic section obtained by collecting data on trace number five from all shot gathers. At station number 60, the first and the second reflection events appear at approximately 35 ms and 41 ms, respectively, while an air wave appears at about 55 ms.

However, in reflection time of 50-60 ms between station numbers 110 and 111 when layers get deeper, the air wave and a second reflection event interfere with each other making an exact arrival time ambiguous.

Small amounts of time delay are noticed compared with the first or second trace (a relatively small offset trace). It is also shown that the strong Rayleigh waves have been recorded between 70 ms and 110 ms in the range of station number 60-120.

Since the first reflection event on trace number 5 is weakly recorded, the first reflection signal is not recognizable in an optimum offset section composed of trace number 5 from all shot gathers.

FIG. 8d is a cross section of subsurface images obtained through the time-varying optimum offset method of the present invention without using velocity information.

Referring to FIG. 8d, false images due to the air wave and Rayleigh waves are removed from the seismic section. The first reflection boundary (that is, a reflection signal appearing near 29 ms at station number 60) is clearly imaged, which is difficult to recognize in the optimum offset section. The second and third reflections are present at 35 ms and 41 ms on the same station number, respectively. Those reflection signals are apparently delayed as in the optimum offset section.

FIG. 8e is a cross section of subsurface images obtained through the time-varying optimum offset method of the present invention using velocity information.

Referring to FIG. 8e, reflection events appear near 26 ms, 31 ms, and 38 ms at station number 60. The reflection times are well matched with the zero-offset reflection times in real nature. However, the trace at station number 96 is not consistent with neighboring traces due to an roll-along error when field data acquired.

As described above, the present invention can obtain more precise subsurface images even without using velocity information than those processed by a conventional method. When using the velocity information, the present invention can produce subsurface images much closer to a real geological section.

According to another embodiment of the present invention, the processor is stored in a memory. An application specific integrated circuit (ASIC) is designed to execute the processor.

The time-varying optimum offset method, system, and apparatus for seismic data processing according to the present invention do not require a process composed of more than ten independent steps or tests to determine optimum parameters in each step, which are indispensable in the conventional CMP stacking method. Consequently, the processing time is greatly shortened from at least one week for the CMP stacking method to only several seconds according to the present invention.

In addition, according to the present invention, a user can make a final subsurface image section without professional knowledge on seismic data processing.

Further, the present invention enables a user to obtain subsurface images much closer to the geological section even without subsurface velocity information than the ones obtained by a conventional optimum offset method.

Moreover, the present invention eliminates the need for processing cost which takes a great portion of exploration cost, thereby greatly reducing investigation cost.

Currently, in civil engineering, construction works, ground-water explorations on a large scale, and environment investigations for the purpose of delineate subsurface geological structures, the number of cases that the high resolution seismic reflection method is applied has rapidly increased. Also, three-dimensional surveys become more popular to image complex subsurface more precisely. Meanwhile since the processing time according to the present invention is almost negligible, the final 3-D images can be obtained on the spot and the processing expense can be greatly reduced. Moreover, since professional knowledge on seismic data processing is unnecessary, the present invention can be easily employed by small service companies having limited number of experts. In addition, the present invention enables even personal computers to perform the process quickly at field and more elaborately in a laboratory. Taking these practical and economical strong points into account, it is expected that the present invention will be widely used in the future.

Although a preferred embodiment of the present invention has been described for illustrative purposes, those who have knowledge in this field will appreciate that various modifications, additions and substitution are possible, without departing from the scope and concept of the invention as disclosed in the accompanying claims.

What is claimed is:

1. A method for processing seismic data by means of a time-varying optimum offset concept, the seismic data being obtained by means of a reflection method, the method comprising the steps of:
receiving basic information of the seismic data acquired by a data acquisition device;
determining a position of a trace window according to time or offset of a seismic trace acquired based on the basic information on the seismic data; and
horizontally stacking only data contained in the trace window of seismic traces.

2. The method as claimed in claim 1, the method further comprising a step of illustrating the data, which have been horizontally stacked so as to produce a surface image section.

3. The method as claimed in claim 1, wherein the basic information comprises vertical and horizontal positions of shots and receivers, shot intervals, geophone spacings, recording length, sample rates, and velocities of air and Rayleigh waves.

4. The method as claimed in claim 1, wherein seismic waves in the window arrive earlier than the faster waves between the air wave and the Rayleigh waves.

5. The method as claimed in claim 1, wherein more precise information is obtained when velocity information of the implemented area is available than when the velocity information is not used.

6. The method as claimed in claim 1, wherein the trace window determines a useful portion of the seismic date, and a length of the trace window can vary according to time or offset.

7. The method as claimed in claim 1, wherein tapers are applied to both sides of the trace window, so as to reduce signal distortion due to a sudden data stoppage of the seismic data on the edge of the both sides of the trace window.

8. A system for processing seismic data by means of a time-varying optimum offset concept, the system comprising:
a memory storing a program; and
a processor connected to the memory so as to execute the program, the processor carrying out a process, the process comprising the steps of:
receiving basic information on the seismic data acquired from a data acquisiton device by the program;
determining a position of a trace window according to time or offset of seismic data acquired based on the basic information of the seismic data; and
horizontally stacking only data contained in the trace window of seismic traces.

9. The system a claimed in claim 8, the process further comprising a step of illustrating the data which have been horizontally stacked so as to reduce a subsurface image section.

10. The system as claimed in claim 8, wherein the basic information comprises vertical and horizontal positions of shots and receivers, shot intervals, geophone space, record length, sample rates, and velocities of the air and Rayleigh waves.

11. The system as claimed in claim 8, wherein waves in the trace window arrive earlier than the faster waves between the air wave and the Rayleigh waves.

12. The system as claimed in claim 8, wherein more precise information is obtained when velocity information on the subsurface in the implemented area is used than when the velocity information of the seismic data is not used.

13. The system as claimed in claim 8, wherein the trace window determines a useful portion of the seismic trace, and a length of the trace window can vary according to time or offset.

14. The system as claimed in claim 8, wherein tapers are applied to both sides of the trace window so as to reduce signal distortion due to a sudden data stoppage of the seismic data on the edges of both sides of the trace window.

15. The system as claimed in claim 8, wherein the processor comprises an Application Specific Integrated Circuit having a design capable of executing the processor.

16. A recording medium for processing seismic data by means of a time-varying optimum offset concept which can be read by a digital processor and has a program embodied in the recording medium, the program including commands which can be executed by a digital processor, the method comprising the steps of:
receiving basic information on the seismic data acquired from a data acquisition device by the program;
determining a position of a trace window according to time or offset of seismic data acquired based on the basic information of the seismic data; and
horizontally stacking only data contained in the trace window of seismic traces.

17. The recording medium as claimed in claim 16, the method further comprising a step of illustrating the data, which have been horizontally stacked so as to produce a subsurface image section.

18. The recording medium as claimed in claim 16, wherein the basic information comprises vertical and horizontal positions of shots and receivers, shot intervals, geophone spacings, recording lengths, sample rates, and velocities of air and Rayleigh waves.

19. The recording medium as claimed in claim 16, wherein waves in the trace window arrive earlier than the faster waves between the air wave and the Rayleigh waves.

20. The recording medium as claimed in claim 16, wherein more precise information is obtained when velocity information on the subsurface in an implemented area is used than when the velocity information of seismic data is not used.

21. The recording medium as claimed in claim 16, wherein the trace window determines a useful portion of seismic trace and a length of the trace window can vary according to time or offset.

22. The recording medium as claimed in claim 16, wherein tapers are applied to both sides of the trace window as as to reduce signal distortion due to a sudden data stoppage of the seismic data on the edges of both sides of the trace window.

23. An apparatus for processing seismic data by means of a time-varying offset concept, the seismic data being obtained by means of a reflection method, the apparatus comprising:
means for receiving basic information of the seismic data acquired by a data acquisition device;
means for determining a position of a trace window according to time or offset of a seismic trace acquired based on the basic information of the seismic data; and
means for horizontally stacking only data contained in the trace window of seismic traces.

24. The apparatus as claimed in claim 23, the apparatus further comprising means for illustrating the data, which have been horizontally stacked so as to produce a subsurface image section.

25. The apparatus as claimed in claim 23, wherein the basic information comprises vertical and horizontal positions of shots and receivers, shot intervals, geophone spacings, record lengths, sample rates, and velocities of the air and Rayleigh waves.

26. The apparatus as claimed in claim 23, wherein waves in the trace window are arrived earlier than the faster waves between the air wave or the Rayleigh waves.

27. The apparatus as claimed in claim 23, wherein more precise information is obtained when velocity information on the subsurface of an implanted area is used than when velocity information is not used.

28. The apparatus as claimed in claim 23, wherein the trace window determines a useful portion of seismic trace and a length of the trace window can vary according to time or offset.

29. The apparatus as claimed in claim 23, wherein tapers are applied to both sides of the trace window so as to reduce signal distortion due to a sudden data stoppage of the seismic data on the edges of both sides of the trace window.
